(19) United States
(12) Patent Application Publication
(10) Pub. No.: US 2014/0231418 A1
(43) Pub. Date: Aug. 21, 2014

(54) MICROWAVE HEATING DEVICE

(71) Applicant: Panasonic Corporation, Osaka (JP)

(72) Inventors: Hikaru Ikeda, Osaka (JP); Motoyoshi Iwata, Osaka (JP); Tomohide Kamiyama, Osaka (JP)

(73) Assignee: PANASONIC CORPORATION, Osaka (JP)

(21) Appl. No.: 14/119,229

(22) PCT Filed: Feb. 15, 2013
(86) PCT No.: PCT/JP2013/000844

§ 371 Date: Nov. 21, 2013

(30) Foreign Application Priority Data
Mar. 26, 2012 (JP) 2012-070317

(51) Int. Cl. H05B 6/64

(52) U.S. Cl. CPC H05B 6/6447; H05B 6/645
USPC 219/705; 219/709

(57) ABSTRACT

An aspect of the present invention provides a microwave heating device for an object having a plurality of parts, the microwave heating device including: a plurality of antennas which emits microwaves to a heating chamber inside; a sensor which detects information from a block model assigned the information indicating a characteristic of each of the parts; a display and input operation unit configured to receive an input of heating conditions for the object; an electromagnetic field analysis unit configured to derive a heating profile by electromagnetic field analysis based on the information detected by the sensor and the heating conditions inputted to the display and input operation unit, the heating profile including microwave emitting conditions for the object; and a control unit configured to control performance of the microwaves emitted from the antennas based on the derived heating profile.

### TECHNICAL FIELD

The present invention relates to a microwave heating device, and particularly to a microwave heating device for heating an object to be heated according to a heating profile.

### BACKGROUND ART

Known conventional microwave heating device represented by a microwave oven measures the surface temperature of an object using an infrared sensor and controls the heating of the object up to a desired temperature. In addition, a microwave heating device has been proposed which controls heating of an object up to a desired temperature by directly capturing the shape of the object using a sensor such as a camera (for example, PTL 1),

### CITATION LIST

### Patent Literature

[PTL 1] Japanese Unexamined Patent Application Publication No. 2003-232527

### SUMMARY OF INVENTION

### Technical Problem

However, the above-described conventional microwave heating device has a problem in that it is not possible to generate an accurate model for electromagnetic field analysis.

The present invention has been devised in view of the above-mentioned situation, and it is an object of the invention to provide a microwave heating device which can generate a simple and more accurate model for electromagnetic field analysis.

### Solution to Problem

In order to achieve the above-described object, an aspect of the present invention provides a microwave heating device for heating an object which is to be heated based on a heating profile, the object having a plurality of parts, the microwave heating device including: a plurality of antennas which emits microwaves to an inside of a heating chamber; a sensor which detects information from a pseudo article in the heating chamber, the information indicating a characteristic of each of the parts, the pseudo article being assigned the information; a heating condition acquisition unit configured to acquire heating conditions for the object; an electromagnetic field analysis unit configured to derive a heating profile by electromagnetic field analysis based on the information detected by the sensor and the heating conditions acquired by the heating condition acquisition unit, the heating profile including microwave emitting conditions for the object; and a control unit configured to control performance of microwaves emitted from the antennas, based on the heating profile derived by the electromagnetic field analysis unit.

It is to be noted that this general or specific aspect may be implemented in the form of a system or a method, and may be implemented in any combination of a system and a method.

### Advantageous Effects of Invention

The microwave heating device according to the present invention is capable of generating a simple and more accurate model for electromagnetic field analysis.

### BRIEF DESCRIPTION OF DRAWINGS

FIG. 1 is a diagram illustrating a configuration of a microwave heating device in Embodiment 1.

FIG. 2 is an illustration schematically showing an object which is to be heated by the microwave heating device in Embodiment 1.

FIG. 3A is an illustration showing a block model which models the object.

FIG. 3B is an illustration showing a block model which models the object.

FIG. 4 is a flow chart illustrating a flow of processing until the object is heat treated using the microwave heating device in Embodiment 1.

FIG. 5 is an illustration showing a block model for an object in Modification 1 of Embodiment 1.

FIG. 6A is an illustration showing a block model for an object in Modification 2 of Embodiment 1.

FIG. 6B is an illustration showing a block model for an object in Modification 2 of Embodiment 1.

FIG. 7 is an illustration showing a block model for an object in Modification 3 of Embodiment 1.

FIG. 8A is an illustration showing a block model for an object in Modification 4 of Embodiment 1.

FIG. 8B is an illustration showing a block model for an object in Modification 4 of Embodiment 1.

FIG. 8C is an illustration showing a block model for an object in Modification 4 of Embodiment 1.

FIG. 9 is an illustration showing respective temperature measurement positions of blocks of an object in Embodiment 2.

FIG. 10 is a graph illustrating a temperature change of each block of the object when the object is heated by the microwave heating device in Embodiment 2.

FIG. 11 is an illustration showing an object to be heat treated in Embodiment 3.

FIG. 12 is a flow chart illustrating a flow of processing until the object is heat treated in Embodiment 3.

FIG. 13 is a flow chart illustrating a flow of processing until the object is heat treated in Embodiment 3.

FIG. 14 is a diagram illustrating a configuration of a microwave heating device in Embodiment 4.

FIG. 15 is a diagram illustrating a configuration of a microwave heating device in Embodiment 5.

FIG. 16 is a diagram illustrating a configuration of a microwave heating device in PTL 1.

### DESCRIPTION OF EMBODIMENTS

(Background of Achieving Aspect of Present Invention)

The inventors have found that the following problems arise in regard to the conventional microwave heating device described in the section of Background Art. Hereinafter, the problems will be described.

PTL 1 discloses a microwave heating device which directly captures the shape of an object by a sensor such as a camera, models the shape of the object, thereby controlling the heating of the object up to a desired temperature. Specifically, PTL 1 discloses a technology which generates a model allowing electromagnetic field analysis based on the shape of a modeled object in an entire housing in which an object is placed, conducts electromagnetic field analysis, and controls the output of a magnetron, the orientation of a microwave reflective plate, and the speed of a turntable for turning an object, using the results of the analysis.

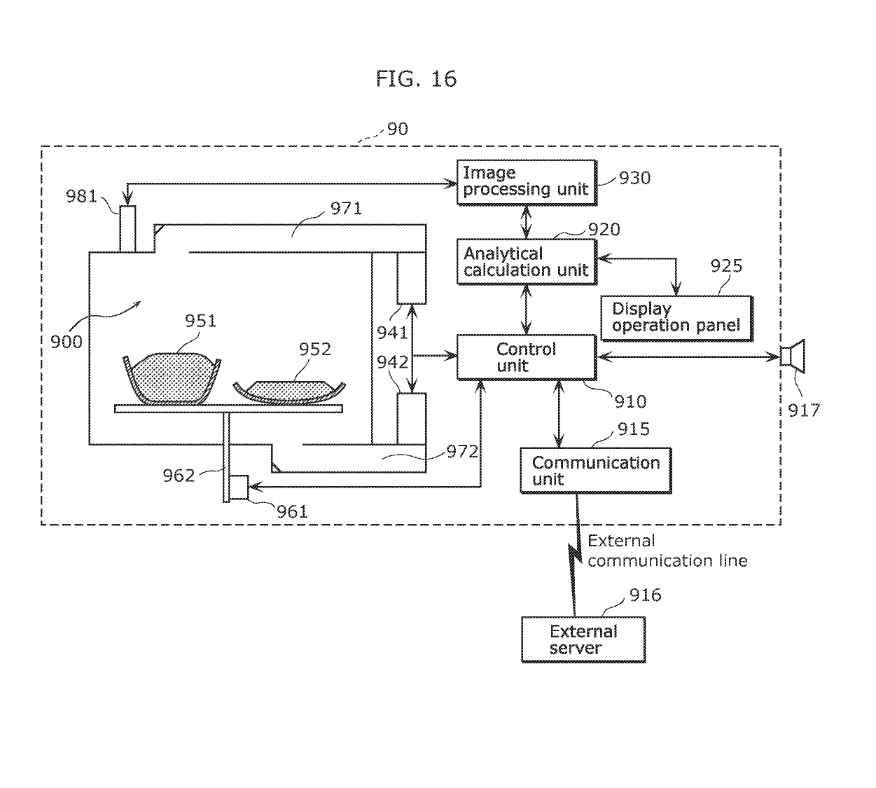

FIG. 16 is a diagram illustrating a configuration of a microwave heating device in PTL 1. A microwave heating device 90 illustrated in FIG. 16 conducts electromagnetic field analysis in a housing inside 900 by the FDTD method, and controls the position such as a rotation angle and the rotational speed of a turntable 962 for placing an object 951 and an object 952, based on the results of the analysis. In this manner, the microwave heating device in PTL 1 controls the heating of an object up to a desired temperature.

However, an object may contain a material (part) with a material constant such as a dielectric constant which changes as the temperature is changed

In this case, it may be difficult to heat such an object up to a desired temperature by a conventional microwave heating device.

For example, when the material (part) as mentioned above is contained in an object, measuring the surface temperature of the object using an infrared sensor does not provide sufficient information as to what types of materials constitute the object (it is difficult to accurately identify the constituents). Thus, the materials (parts) which constitute the object cannot be heated up to a desired temperature.

It may be difficult for the microwave heating device in PTL 1 to heat the object up to a desired temperature.

Specifically, the microwave heating device in PTL 1 uses a sensor such as a camera to capture the color and shape of the object and measures the weight of the object based on the surface of the object, then generates a model for electromagnetic field analysis of the object. In order to perform microwave heating control, the microwave heating device conducts electromagnetic field analysis using a model for electromagnetic field analysis of the object, and generates a heating profile for controlling the portions (parts) to be heated and the heating time of the portions.

However, measuring dimensions such as the outer diameter of the object does not provide sufficient information as to what types of materials constitute the inside of the object. In addition, when an object contains a material (part) with a material constant such as a dielectric constant which changes as the temperature is changed, a problem arises that it is not possible to accurately generate a model for electromagnetic field analysis of the object. For this reason, a heating profile cannot be accurately generated and the object cannot be heated up to a desired temperature.

It is to be noted that a model for electromagnetic field analysis of the object can be accurately generated by making a three-dimensional model with CAD. However, a process of inputting the values for forming a three-dimensional model with CAD is generally complicated, and only specialists can handle the process.

In view of the above situation, the inventors have devised a microwave heating device which is capable of generating a simple and more accurate model for electromagnetic field analysis.

In order to achieve the above object, an aspect of the present invention provides a microwave heating device for heating an object which is to be heated based on a heating profile, the object having a plurality of parts, the microwave heating device including: a plurality of antennas which emits microwaves to an inside of a heating chamber; a sensor which detects information from a pseudo article in the heating chamber, the information indicating a characteristic of each of the parts, the pseudo article being assigned the information; a heating condition acquisition unit configured to acquire heating conditions for the object; an electromagnetic field analysis unit configured to derive a heating profile by electromagnetic field analysis based on the information detected by the sensor and the heating conditions acquired by the heating condition acquisition unit, the heating profile including microwave emitting conditions for the object; and a control unit configured to control performance of microwaves emitted from the antennas, based on the heating profile derived by the electromagnetic field analysis unit.

With this configuration, it is possible to achieve a microwave heating device which is capable of generating a simple and more accurate model for electromagnetic field analysis.

This allows an optimal heating profile to be generated for an object, thus it is possible to achieve optimal heating by which the object can be heated up to a desired temperature.

More specifically, with a microwave heating device according to the aspect, a block model is used and measured by a sensor, then a three-dimensional model of an object is generated, the block model being generated easily with pieces of blocks which are different divided pieces of material elements representing the object. An electromagnetic field analysis is conducted using the generated three-dimensional model, and a heating profile of the object can be derived. Thus, subsequently, the object is replaced by the block model, and the frequency, phase, and output power of microwaves outputted from multiple antennas are controlled based on the generated heating profile, and thus each part of the object can be heated up to a desired temperature.

For example, the electromagnetic field analysis unit may be configured to generate a three-dimensional model using the information detected by the sensor and to derive the heating profile satisfying the heating conditions, by using the three-dimensional model.

The pseudo article may include a plurality of blocks, each of which corresponds to a different one of the parts and may be assigned the information on the different part.

Instead of the object, the pseudo article may be placed in the heating chamber.

The information may include at least one of a position, a size, a shape, a dielectric constant, and a thermal conductivity.

Lines may be added to enhance the outlines of the blocks, and the sensor may recognize boundaries between the blocks with the line to detect the information from the blocks respectively corresponding to the parts.

A surface of each of the blocks may be labeled with a symbol which indicates the corresponding information, and the sensor may detect the information by recognizing the symbol.

The symbol may be a bar code.

Each of the blocks may be labeled with a color which indicates the corresponding information, and the sensor may detect the information by recognizing the color.

The pseudo article may include a plurality of blocks stacked in layers, the blocks included in the pseudo article respectively correspond to the parts, and out of the information assigned to the blocks included in the pseudo article, information to be assigned to a visually unrecognizable block from outside may be assigned to a block visible from a surface of the pseudo article instead of the visually unrecognizable block.

The object may be placed in the heating chamber and heated by microwaves which are emitted from the antennas, the sensor may further detect temperatures of the parts of the object placed in the heating chamber, the control unit may be configured to compare differences between the temperatures of the parts of the object detected by the sensor and a target temperature according to the heating profile derived by the electromagnetic field analysis unit, the electromagnetic field analysis unit may be configured to derive an updated heating profile according to the differences, and the control unit may be configured to control an operation of the antennas based on the updated heating profile to cause the antennas to emit microwaves from the antennas.

The microwave heating device may further include a communication unit configured to transmit a model for the object and to receive modification information indicating a modified model for the object. When the communication unit receives the modification information, the electromagnetic field analysis unit may derive the heating profile based on the modification information and the heating conditions inputted to the heating condition acquisition unit.

The object may have a plurality of parts and be placed in the heating chamber of the microwave heating device, and the parts of the object may be each labeled with the pseudo article.

That is, each part of the object is labeled with a pseudo article which is assigned information indicating a corresponding characteristic of the part. With this configuration, a three-dimensional model for the object can be generated by measuring with a sensor the pseudo article assigned to each part of the object.

The pseudo article may be further assigned a heating condition for a corresponding one of the parts, the heating condition being included in the information indicating a characteristic of each of the parts.

The heating condition may include a condition which indicates that whether or not a corresponding one of the parts is to be heated and a level of heating when the corresponding part is to be heated.

When heating conditions different from the heating conditions assigned to the pseudo article are inputted, the heating condition acquisition unit may be configured to acquire the different heating conditions as heating conditions for the object instead of the heating conditions assigned to the pseudo article.

It is to be noted that the present invention is not only implemented in the form of microwave heating device, but also in the form of chemical reaction device or drying device each having some of the functions of the microwave heating device.

Hereinafter, an embodiment of the present invention will be described with reference to the drawings.

Any of the embodiments described below illustrates a specific example of the present invention. Numerical values, shapes, materials, components, arrangement positions and connection configurations of the components, steps, the order of the steps shown in the following embodiment provide an example, and are not intended to limit the present invention. Any component which is included in the components of the following embodiments and is not recited in the independent claim providing the most generic concept will be described as an arbitrary component included in an embodiment.

### Embodiment 1

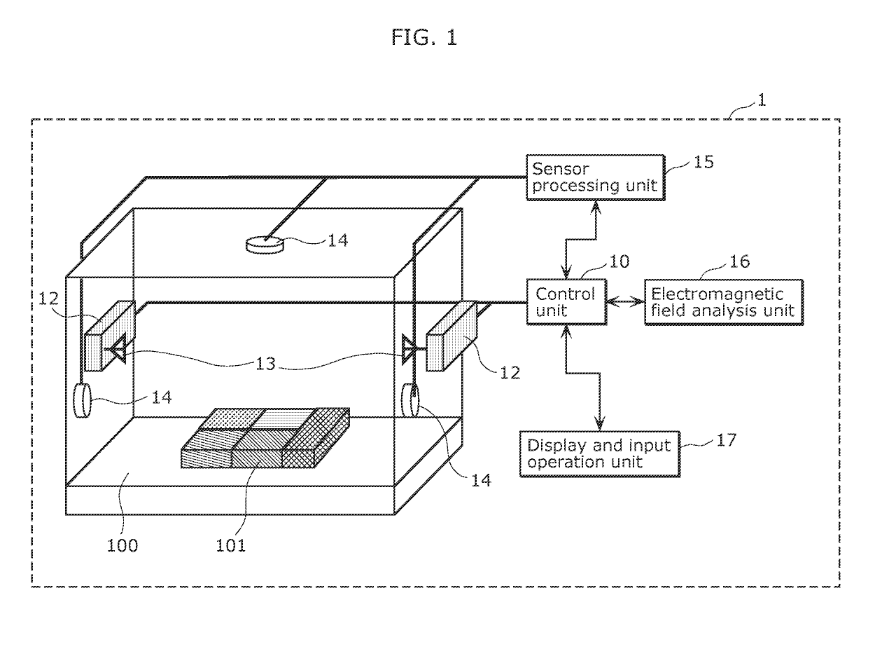

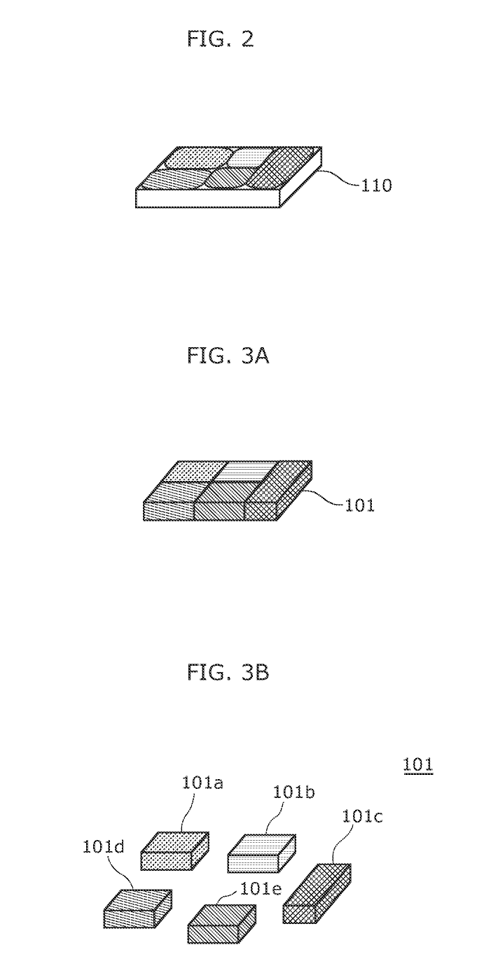

FIG. 1 is a diagram illustrating a configuration of a microwave heating device 1 in Embodiment 1. FIG. 2 is an illustration schematically showing an object 110 which is to be heated by the microwave heating device in Embodiment 1. FIGS. 3A and 33 are each an illustration showing a block model which models the object.

The microwave heating device 1 illustrated in FIG. 1 heats the object 110 which is to be heated based on a heating profile. More specifically, the microwave heating device 1 emits microwaves to the object 110 so as to heat the object 110 according to a heating profile derived from an electromagnetic field analysis.

The object 110 is an object to be actually heated by the microwave heating device 1, and has parts (a plurality of parts) having different material elements as illustrated in FIG. 2. For example, when it is assumed that a box lunch includes cooked rice and multiple side dishes, the cooked rice and the multiple side dishes correspond to the parts having different material elements. In many cases, the cooked rice and the side dishes are not heated up to the same temperature under the same heating conditions. A user may request different desired temperatures (target temperatures) for the cooked rice and the side dishes. Thus, the parts (a plurality of parts) having different material elements included in the object 110 may have respective heating conditions and target temperatures. Needless to say, the object 110 is not limited to the above example. For example, the object 110 may be made of wood or ceramic. That is to say, when the object 110 includes parts having different material elements, the material of the object and the material of each part are not limited to specific material.

Hereinafter, the detailed configuration of the microwave heating device 1 will be described.

The microwave heating device 1 includes a control unit 10, microwave generators 12, antennas 13, a sensor 14, a sensor processing unit 15, an electromagnetic field analysis unit 16, and a display and input operation unit 17. It is to be noted that in FIG. 1, the inside of the heating chamber is illustrated as a heating chamber inside 100, FIG. 1 illustrates the manner in which a block model 101 which models the object 110 is placed as a pseudo article in the heating chamber inside 100 of the microwave heating device 1.

The microwave generators 12 oscillate frequencies by a VCO (Voltage Controlled Oscillator), stabilizes the frequency by a PLL (Phase Locked Loop), then amplifies the frequency by a power amplifier to output desired microwaves. The microwave generators 12 each have a function of changing an output frequency, an electric power, and a phase.

The antennas 13 correspond to a plurality of antennas in the present invention, and emits microwaves in the heating chamber inside 100. Specifically, the antennas 13 emit microwaves to the heating chamber inside 100 which has been outputted by the microwave generators 12.

The sensor 14 corresponds to the sensor in the present invention, and detects information from a pseudo article which is assigned information indicating respective characteristics of a plurality of parts in the heating chamber inside 100. Specifically, the sensor 14 detects (monitors) information of at least one of the size, shape, color, and temperature of the block model 101 which is placed instead of the object 110 in the heating chamber inside 100.

In the present embodiment, as illustrated in FIG. 3A, the block model 101 is a three-dimensional block model which models the object 110 by substituting block pieces for different material elements of the object 110. The block model 101 is placed instead of the object 110 in the heating chamber inside 100.

The block model 101 corresponds to the pseudo article in the present invention, and includes a plurality of block pieces 101a to 101e which respectively correspond to a plurality of parts, and each of the block pieces is assigned information which indicates the characteristic of a corresponding part of the object 110. The information includes at least one of the position, size, shape, dielectric constant, and thermal conductivity of the corresponding part, and each of the plurality of block pieces 101a to 101e is assigned information of a corresponding part of the plurality of parts, the information including at least one of the position, size, shape, dielectric constant, and thermal conductivity of the part. That is, the block pieces 101a to 101e illustrated in FIG. 3B respectively correspond to the plurality of parts of the object 110, and constitute the block model 101. The sensor 14 then detects information of at least one of the position, size, shape, color, and temperature, the information being assigned to each of the plurality of block pieces 101a to 101e included in the object 110 and indicating the characteristic of a corresponding part.

The sensor processing unit 15 generates a three-dimensional model which models the object 110 using the information detected by the sensor 14. Specifically, the sensor processing unit 15 generates a three-dimensional model of the object 110 based on the information detected (obtained) by the sensor 14.

More specifically, the sensor processing unit 15 generates a three-dimensional model of the object 110 based on the information detected (obtained) by the sensor 14 by assuming that the block model 101 represents the object 110.

The electromagnetic field analysis unit 16 corresponds to the electromagnetic field analysis unit in the present invention, and derives a heating profile by electromagnetic field analysis based on the information detected by the sensor 14 and the heating conditions inputted to the display and input operation unit 17, the heating profile including microwave emission conditions on the object 110. Specifically, the electromagnetic field analysis unit 16 generates a three-dimensional model using the information detected by the sensor 14, and derives a heating profile, which satisfies the heating conditions, by using the three-dimensional model.

More specifically, the electromagnetic field analysis unit 16 uses the three-dimensional model generated by the sensor processing unit 15 to derive a heating profile by electromagnetic field analysis, the heating profile achieving the heating conditions designated by the display and input operation unit 17.

The display and input operation unit 17 corresponds to the heating condition acquisition unit in the present invention, and acquires heating conditions over the object. Specifically, the display and input operation unit 17 receives an input the heating conditions of the object 110, and transmits the input to the electromagnetic field analysis unit 16. For example, a user sets heating conditions for the block pieces 101a to 101e via the display and input operation unit 17. It is to be noted that the heating conditions for the block pieces 101a to 101e may be different from each other, or part or all of the heating conditions may be the same.

The display and input operation unit 17 also has a function of displaying heating operation switches, operation content, and heating conditions for users of the microwave heating device 1.

The control unit 10 corresponds to the control unit in the present invention, and emits microwaves to the object 110 by controlling the operation of the microwave generators 12 based on the heating profile derived by the electromagnetic field analysis unit 16. Specifically, the control unit 10 is a control unit which emits microwaves to the object 110 by controlling the microwave generators 12 based on the heating profile derived by the electromagnetic field analysis unit 16.

The microwave heating device 1 is configured as described above.

In this manner, the microwave heating device 1 uses a simple block model 101 to generate a model for electromagnetic field analysis so as to be able to derive a heating profile of the object 110, the block model being implemented with block pieces which are different divided pieces of material elements instead of the object 110 having a plurality of parts. That is, the microwave heating device 1 can easily conduct an electromagnetic field analysis by using the block model 101 as a model of the object 110.

Next, a series of processes until the object 110 is heat treated will be described by using the microwave heating device 1 configured as described above.

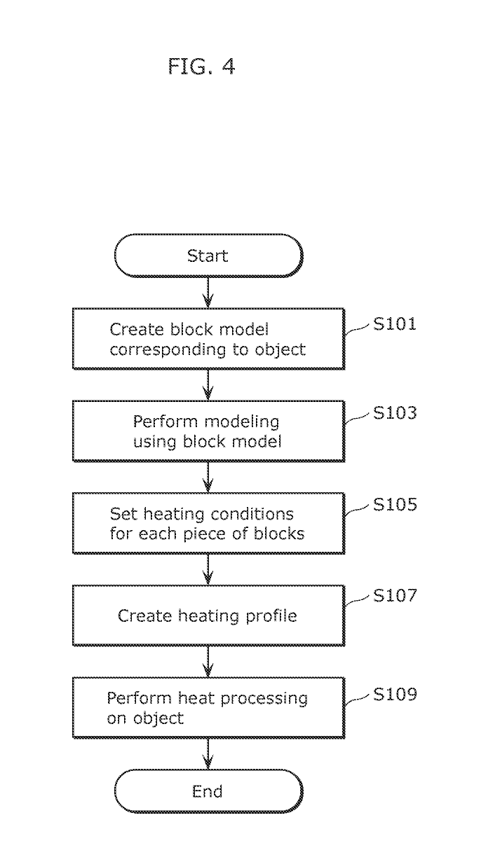

FIG. 4 is a flow chart illustrating a flow of processing until the object 110 is heat treated using the microwave heating device in Embodiment 1.

First, the block pieces 101a to 101e illustrated in FIG. 3B are combined to generate the block model 101 corresponding to the object 110 (S101). Specifically, for example, a user, who performs heat treatment on the object 110 using the microwave heating device 1, generates the block model 101 by combining the block pieces 101a to 101e which are the same or similar to the parts included in the object 110. The block pieces 101a to 101e are each an object which has a fixed constant shape.

Next, the generated block model 101 is put in the heating chamber inside 100 of the microwave heating device 1, and modeling of the object 110 is performed using the block model 101 (S103). The modeling is processing in which the sensor processing unit 15 generates a three-dimensional model of the object 110 based on the information obtained by the sensor 14 by assuming that the block model 101 represents the object 110.

Next, heating conditions for the block pieces 101a to 101e included in the object 110 are set in the microwave heating device 1 (S105). Specifically, a user sets heating conditions for the block pieces 101a to 101e via the display and input operation unit 17. The heating conditions for the block pieces 101a to 101e may be different from each other, or part or all of the heating conditions may be the same. The heating conditions include not only the final heating temperature but also a temperature profile, the temperature in relation to time. Then, the microwave heating device 1 performs heating processing after heating conditions are set for the parts included in the object 110 which is actually to be heated.

Next, the microwave heating device 1 generates a heating profile for performing heat treatment on the object 110 (S107).

Specifically, the electromagnetic field analysis unit 16 generates a heating profile based on the three-dimensional model of the object 110 generated by the sensor processing unit 15 in S103, and the heating conditions for the object 110 set in S105. The electromagnetic field analysis unit 16 may generate a heating profile for performing a single heat treatment on the entire object 110 depending on the set heating conditions. The electromagnetic field analysis unit 16 may generate a heating profile for performing different heat treatments for the parts included in the object 110 depending on the set heating conditions.

Next, the microwave heating device 1 performs heat treatment on the object 110 (S109).

Specifically, a user first puts the object 110 in the heating chamber inside 100 of the microwave heating device 1, the object 110 to be actually heated instead of the block model 101. Subsequently, the microwave heating device 1 outputs microwaves from the antennas 13 by controlling the microwave generators 12 based on the generated heating profile. In this manner, the microwave heating device 1 performs heat treatment on the object 110 placed in the heating chamber inside 100 by emitting microwaves to the object 110 from the antennas 13.

Assume that different heating conditions are set for the block pieces 101a to 101e included in the object 110 in S105. In this case, the microwave heating device 1 does not uniformly heat the entire object 110, but heats the parts of the object 110 under different conditions, the parts respectively corresponding to the block pieces 101a to 101e included in the object 110.

The heating conditions set for the block pieces 101a to 101e included in the object 110 are, for example, conditions of a temperature range to which the block pieces are heated. Needless to say, it is also possible to set a condition that some of the block pieces are not heated. In other words, when the object is foodstuff, temperature treatment may be performed with different temperature targets according to the foodstuffs included in the object, or some of the foodstuffs may not be heated.

In this manner, the microwave heating device 1 performs heat treatment on the object 110.

As described above, a simple and more accurate model for electromagnetic field analysis can be generated by the microwave heating device 1 in Embodiment 1.

More specifically, the block model 101, which is built with block pieces like a toy block, is substituted for the object 110, thus a three-dimensional model of the object 110, which is used for electromagnetic field analysis, can be easily generated using the block model 101. In this manner, a heating profile for performing optimal heating on the object 110 can be easily and accurately generated by the microwave heating device 1. Consequently, the effect is achieved that the parts included in the object 110 can be heated to respective desired temperatures.

It is to be noted that the block pieces 101a to 101e may have different sizes, shapes, and colors, or part or all of the block pieces may have the same attributes in at least part the size, shape, and color. An example has been described where the block model 101 includes the five block pieces 101a to 101e, however, the invention is not limited to this. For example, the block model 101 may include less than five block pieces or more than five block pieces.

In addition, the shapes of the block model 101 and the block pieces 101a to 101e included therein are not limited to a rectangular parallelepiped and may be various three-dimensional shapes. The block model 101 does not necessarily include the block pieces 101a to 101e having substantially the same size as the parts of the object 110, and may include general-purpose block pieces having a size smaller than the parts of the object 110.

[Modification 1]

In this modification, another example of a block model which is substituted for the object 110 will be described.

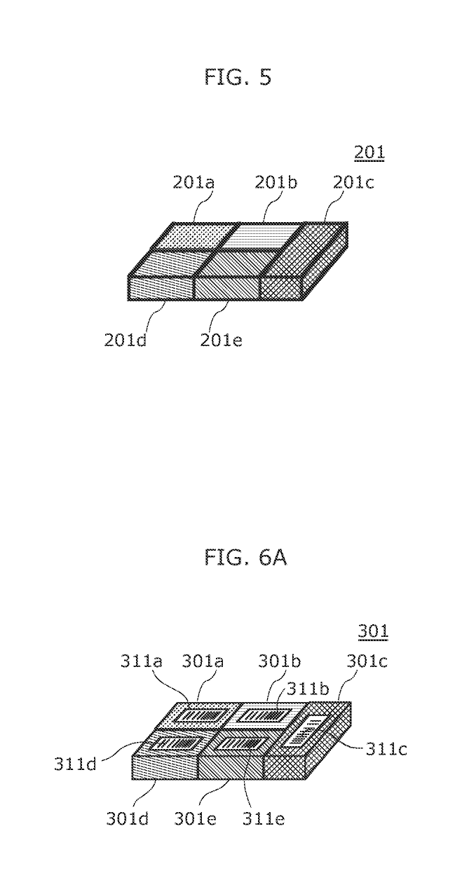

FIG. 5 is an illustration showing a block model 201 for the object 110 in Modification 1 of Embodiment 1.

The block model 201 illustrated in FIG. 5 differs from the block model 101 according to Embodiment 1 in that the outline of the block pieces 201a to 201e is illustrated with a line which emphasizes the outline. That is, the size and shape of the block pieces in the block model 201 are the same as those of the block model 101 illustrated in FIG. 3A. However, each of the sides included in the block pieces 201a to 201e is illustrated with a thick line which emphasizes the outline of the block pieces 201a to 201e. Here, the thickness of the line is, for example, greater than or equal to 5 mm.

In this modification, the flow of heat treatment of the object 110 is substantially the same as that of Embodiment 1, however, the processing in S103 has a characteristic. That is, in S103, the sensor 14 can detect the positions, sizes, and shapes of the block pieces 201a to 201e more accurately because each side included in the block pieces 201a to 201e is illustrated with a thick line.

That is, the sensor 14 recognizes the illustrated line as the boundary between the block pieces 201a to 201e, and thus can recognize the boundary between the block pieces 201a to 201e more accurately (in high accuracy). Consequently, the sensor 14 can detect information for generating a heating profile for the object 110 from the block pieces 201a to 201e corresponding to the respective parts.

Other processing is the same as the processing described in Embodiment 1, and thus a description thereof is omitted.

As described above, a simple and more accurate model for electromagnetic field analysis can be generated by this modification.

More specifically, the block model 201, which is built with block pieces like a toy block, is substituted for the object 110, thus a three-dimensional model of the object 110, which is used for electromagnetic field analysis, can be easily generated using the block model 201. In this manner, a heating profile, which satisfies heating conditions for performing optimal heating on the object 110, can be easily and accurately generated. Consequently, the effect is achieved that the parts included in the object 110 can be heated to respective desired temperatures.

In this modification, an example has been described where each of the sides included in the block pieces 201a to 201e is illustrated with a thick line which emphasizes the outline of the block pieces 201a to 201e. However, as long as the same effect is achieved, the invention is not limited to this. For example, each side and its periphery (boundary) may have a distinct color or may be made of a material which changes the amount of reflection of light, and still a similar effect is achieved.

[Modification 2]

In this modification, an example of a block model which is different from the block model in Modification 1 will be described. Specifically, an example will be described in which each of the surfaces of the block pieces included in a block model is labeled with a symbol indicating corresponding information. The sensor 14 detects the corresponding information by recognizing the symbol. In the following, it describes that a sign is a bar code as an example.

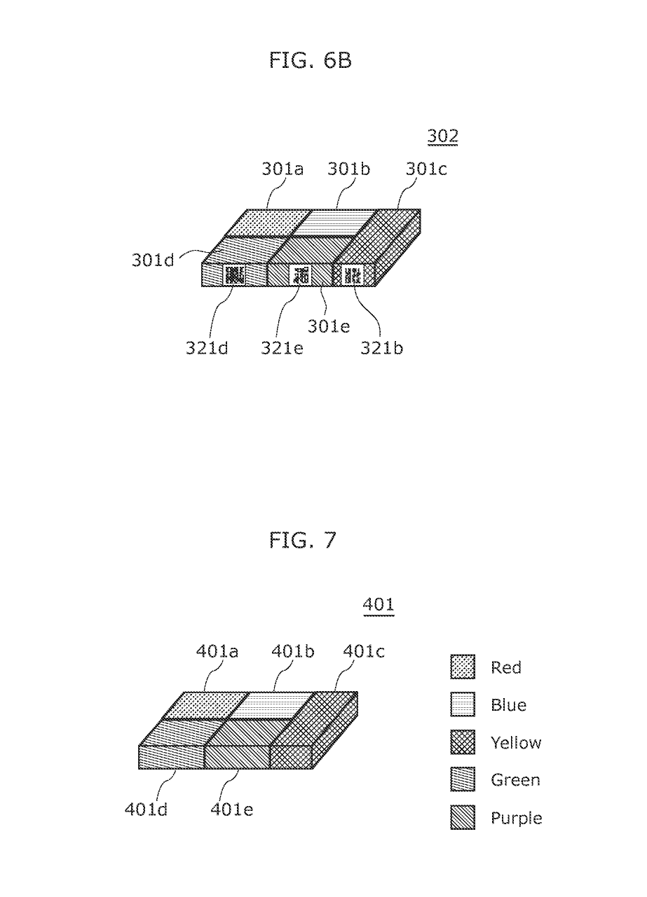

FIGS. 6A and 6B are each an illustration showing a block model of the object 110 in Modification 2 of Embodiment 1.

The block model 301 illustrated in FIG. 6A differs from the block model 101 according to Embodiment 1 in that the surfaces of the block pieces 301a to 301e are each labeled with a bar code (one-dimensional bar code). Similarly, the block model 302 illustrated in FIG. 6B differs from the block model 101 according to Embodiment 1 in that the surfaces of the block pieces 301a to 301e are each labeled with a two-dimensional bar code.

More specifically, the block pieces 301a to 301e in the block model 301 and the block model 302 have the same size and shape as the block pieces in the block model 101 illustrated in FIG. 3A. On the other hand, the surfaces of the block pieces 301a to 301e are respectively labeled with one-dimensional bar codes 311a to 311e as illustrated in FIG. 6A or two-dimensional bar codes 321a to 321e as illustrated in FIG. 6B. That is, the surfaces of the block pieces 301a to 301e are respectively labeled with the one-dimensional bar codes 311a to 311e or the two-dimensional bar codes 321a to 321e at positions recognizable by the sensor 14.

The one-dimensional bar codes 311a to 311e and the two-dimensional bar codes 321a to 321e are bar codes each including an identification number and individual information necessary for electromagnetic field analysis of the corresponding one of the block pieces 301a to 301e. The individual information includes, for example, information of at least one of the size, shape, dielectric constant, and thermal conductivity of a corresponding block piece.

In this modification, the flow of heat treatment of the object 110 is substantially the same as that of Embodiment 1, however, the processing in S103 has a characteristic. That is, in S103, the sensor 14, which has a function of optically recognizing characters and symbols, reads information from the one-dimensional bar codes 311a to 311e or the two-dimensional bar codes 321a to 321e, and outputs the information to the sensor processing unit 15. The sensor processing unit 15 converts the information obtained from the sensor 14 into information including at least one of the size, shape, dielectric constant, and thermal conductivity of each of the block pieces 301a to 301e, and generates a three-dimensional model of the object 110.

Other processing is the same as the processing described in Embodiment 1, and thus a description thereof is omitted.

As described above, a simple and more accurate model for electromagnetic field analysis can be generated by this modification.

Specifically, bar codes are placed on respective surfaces of the block pieces 301a to 301e of the block model 301 which is substituted for the object 110, thus identification of the block pieces 301a to 301e and physical properties of the block pieces 301a to 301e can be easily obtained. Consequently, a three-dimensional model of the object 110, which is used for electromagnetic field analysis, can be easily generated using the block model 301, thus a heating profile, which satisfies heating conditions for performing optimal heating on the parts of the object 110, can be easily and accurately generated. Consequently, the effect is achieved that the parts included in the object 110 can be heated to respective desired temperatures.

In this modification, the case has been described where the surfaces of the block pieces 301a to 301e are respectively labeled with the one-dimensional bar codes 311a to 311e or the two-dimensional bar codes 321a to 321e. However, the invention is not limited to this case. Each surface of the block pieces 301a to 301e may be labeled with a one-dimensional bar code or a two-dimensional bar code.

In this modification, the case has been described where the block pieces 301a to 301e are each labeled with a bar code, however, the invention is not limited to this case. As long as the block pieces 301a to 301e can be identified and the physical properties of pieces of the block pieces 301a to 301e can be obtained accordingly, the bar code may be replaced by a simple symbol. In this case, the simple symbol may be linked to a physical property, and the sensor processing unit 15 may identify each block piece based on the simple symbol to obtain a corresponding physical property.

[Modification 3]

In this modification, an example of a block model, which is different the examples in Modification 1 and Modification 2 will be described. Specifically, an example will described in which each of the block pieces included in a block model is labeled with a color which indicates corresponding information. The sensor 14 detects the corresponding information by recognizing the color.

FIG. 7 is an illustration showing a block model 401 for the object 110 in Modification 3 of Embodiment 1.

The block model 401 illustrated in FIG. 7 differs from the block model 101 according to Embodiment 1 in that block pieces 401a to 401e are colored differently.

More specifically, the block pieces 401a to 401e in the block model 401 have the same size and shape as the block pieces in the block model 101 illustrated in FIG. 3A. On the other hand, the block model 401 includes the block pieces 401a to 401e which are colored differently. Each of the colors applied to the block pieces 401a to 401e is linked to information which includes, for example, information of at least one of the size, shape, dielectric constant, and thermal conductivity of a corresponding block piece. In this modification, for example, the block piece 401a is colored in red, the block piece 401b is colored in blue, the block piece 401c is colored in yellow, the block piece 401d is colored in green, and the block piece 401e is colored in purple.

In this modification, the flow of heat treatment of the object 110 is substantially the same as that of Embodiment 1, however, the processing in S103 has a characteristic. That is, in S103, the sensor 14, which has a function of optically recognizing characters and symbols, reads information from the block pieces 401a to 401e, and outputs the information to the sensor processing unit 15. The sensor processing unit 15 converts the information obtained from the sensor 14 into information including at least one of the size, shape, dielectric constant, and thermal conductivity of each of the block pieces 401a to 401e, and generates a three-dimensional model of the object 110.

Other processing is the same as the processing described in Embodiment 1, and thus a description thereof is omitted.

As described above, a simple and more accurate model for electromagnetic field analysis can be generated by this modification.

Specifically, colors are applied to respective surfaces of the block pieces 401a to 401e of the block model 401 which is substituted for the object 110, thus identification of the block pieces 401a to 401e and physical properties of the block pieces 401a to 401e can be easily obtained. Consequently, a three-dimensional model of the object 110, which is used for electromagnetic field analysis, can be easily generated using the block model 401, thus a heating profile, which satisfies heating conditions for performing optimal heating on desired parts of the object 110, can be easily and accurately generated. Consequently, the effect is achieved that the parts included in the object 110 can be heated to respective desired temperatures.

In this modification, the colors applied to the block pieces 401a to 401e may be the same as or similar to the colors of the parts included in the object 110. In this case, when the block model 401, which is substituted for the object 110, is assembled using the block pieces 401a to 401e, rate of error such as an assembly error can be reduced. The color and physical property of the block pieces 401a to 401e are associated with each other, thus the effect is achieved that even a user, who is unfamiliar with mechanical assembling, can easily generate a model because the block pieces 401a to 401e only need to be assembled according to the colors in the object 110.

In this modification, coloring of the block pieces 401a to 401e is not necessarily performed on the entire block pieces 401a to 401e, and may be performed on only part of the block pieces 401a to 401e. In this case, it is sufficient that colored block pieces are arranged at positions recognizable by the sensor 14.

[Modification 4]

In Modifications 1 to 3, the case has been described where the block model is formed with one layer. However, the invention is not limited to this case. In this modification, a case will be described where a block model is formed (in a multilayer) with stacked multiple layers. In the following, a case will be described where a block model is formed with three layers (three steps).

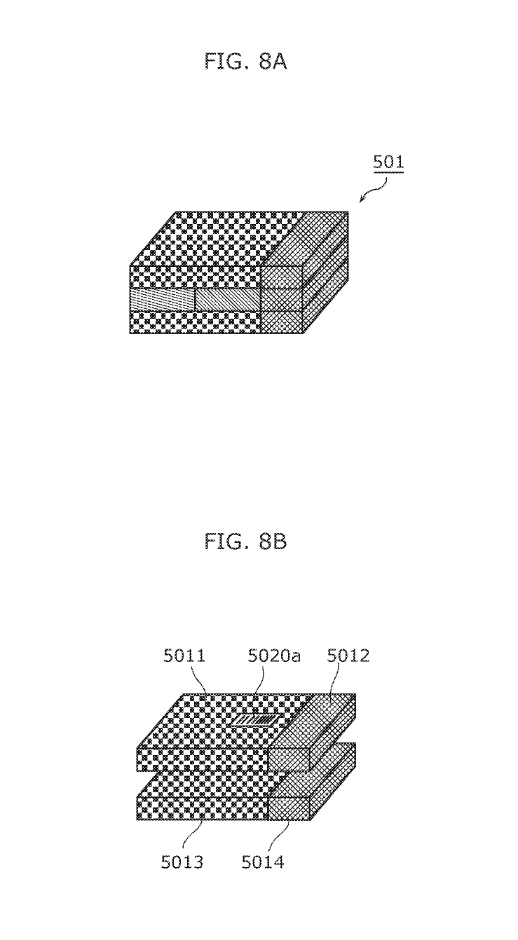

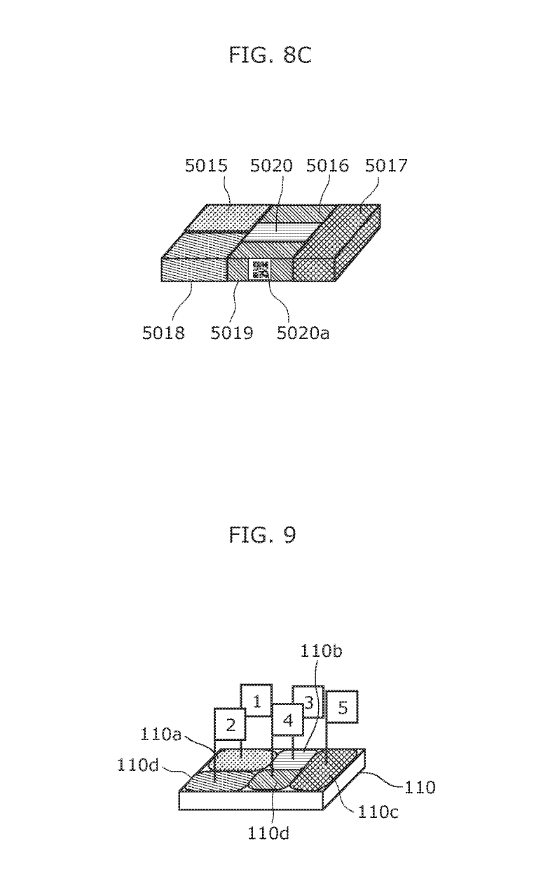

FIGS. 8A to 8C are each an illustration showing a block model for an object in Modification 4 of Embodiment 1. FIG. 8A illustrates a block model 501 which models an object with multiple layers, and the block model 501 includes three layers. FIG. 8B is an illustration showing block pieces 5011 to 5014 included in the top and bottom layers out of the three layers included in the block model 501, and FIG. 8C is an illustration showing block pieces 5015 to 5019 included in the middle layers out of the three layers included in the block model 501. The block pieces 5011 to 5014 included in the block model 501 respectively correspond to a plurality of parts in the object.

In the block model 501 of an object illustrated in FIG. 8A, a block piece 5020 at the center of the middle layer illustrated in FIG. 8C cannot be visually recognized from the outside. Thus, the sensor 14 cannot recognize the block piece 5020 under the current conditions.

Thus, in this modification, a block piece 5019 or a block piece 5011 which is adjacent to the block piece 5020 is labeled with a bar code 5020a which indicates the information of the block piece 5020. That is, the information assigned to a visually unrecognizable block piece out of the information assigned to the block pieces included in the block model 501 is assigned to a block piece on the surface of block model 501 instead of the visually unrecognizable block piece. Here, the bar code 5020a includes information of at least one of the size, shape, dielectric constant, and thermal conductivity of the block piece 5020. In this manner, the sensor 14 detects the information of the bar code 5020a, and the sensor processing unit 15 can acquire the information related to the block piece 5020 by processing the information obtained by the sensor 14.

It is to be noted that the bar code 5020a may be a two-dimensional bar code as illustrated in FIG. 8C, or a one-dimensional bar code as illustrated in FIG. 8B. and the invention is not limited to the examples illustrated in FIGS. 8A and 8C.

As described above, a simple and more accurate model for electromagnetic field analysis can be generated by this modification.

Specifically, the block model 501, which is built with block pieces three-dimensionally like a toy block, is substituted for the object, thus a three-dimensional model of the object 110, which is used for electromagnetic field analysis, can be easily generated using the block model 501. Here, a bar code indicating the information of the block piece 5020 is labeled on a block piece which is adjacent to the block piece 5020, the block piece 5020 not being exposed through an outer surface of the block model 501, and thus the sensor 14 can detect the information of the block piece 5020.

In this manner, a heating profile, which satisfies heating conditions for performing optimal heating on the object, can be easily and accurately generated. Consequently, the effect is achieved that the parts included in the object 110 can be heated to respective desired temperatures.

In this modification, the case has been described where the block piece 5011 or the block piece 5019, which is adjacent to the block piece 5020, is labeled with a bar code, however, the invention is not limited to this case. It is sufficient that the block piece 5020 can be identified and corresponding information can be obtained. For example, the block piece 5015, the block piece 5017, or the block piece 5019 may serve as a block piece adjacent to the block piece 5020. A block piece adjacent to the block piece 5020 may be labeled with a simple symbol by which the block piece 5020 can be identified and corresponding information can be obtained.

### Embodiment 2

When the object 110 is actually heated by applying a heating profile which has been generated by using various methods described in Embodiment 1 based on the block model which is substituted for the object 110, the parts of the object 110 may not be heated up to respective desired temperatures. In the present embodiment, as a solution to the above problem, an example of a method of modifying a heating profile will be described.

FIG. 9 is an illustration showing respective temperature measurement positions of blocks of the object 110 in Embodiment 2.

The temperatures of parts 110a to 110d of the object 110 are measured at temperature measurement positions 1 to 5. The sensor detects the temperatures of corresponding parts at the temperature measurement positions 1 to 5. The parts 110a to 110d of the object 110 correspond to the block pieces of a block model which is substituted for the object 110.

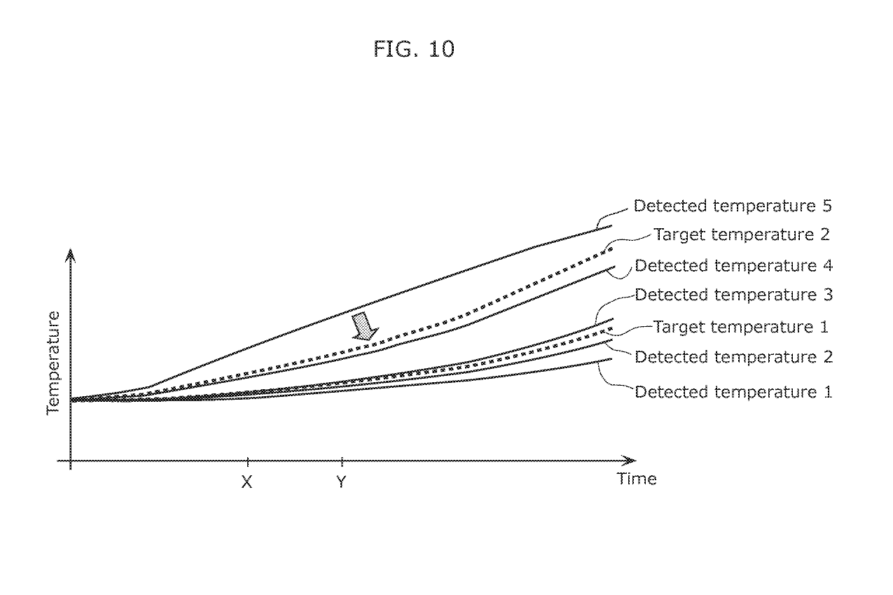

FIG. 10 is a graph illustrating a temperature change of each block of the object when the object is heated by the microwave heating device 1 in Embodiment 2. In FIG. 10, the horizontal axis indicates heating time and the vertical axis indicates temperature.

Target temperatures 1 and 2 illustrated in FIG. 10 are indicated by a dashed line, and represent a target heating profile which is used to heat a corresponding part up to a target temperature. In the present embodiment, the target temperature 1 is a target temperature (target heating profile) for the parts 110a to 110c of the object 110, and the target temperature 2 is a target temperature (target heating profile) for the parts 110d and 110e of the object 110.

Detected temperatures 1 to 5 are actual temperatures (temperature variations) of the object detected by the sensor 14. In the present embodiment, the detected temperature 1 is a temperature of the part 110a of the object 110 detected by the sensor 14, and the detected temperature 2 is a temperature of the part 110b of the object 110 detected by the sensor 14. In addition, the detected temperature 3 is a temperature of the part 110c of the object 110 detected by the sensor 14, and the detected temperature 4 is a temperature of the part 110d of the object 110 detected by the sensor 14. Similarly, the detected temperature 5 is a temperature of the part 110e of the object 110 detected by the sensor 14.

The sensor 14 detects a temperatures of each the parts 110a to 110e of the object 110 which is placed in the heating chamber inside 100 and heated by emission of microwaves from the plurality of antennas 13. In FIG. 10, the temperatures of the parts 110a to 110e are detected at time X and time Y, for example.

The control unit 10 compares the differences between the temperatures of the parts 110a to 110e of the object 110 detected by the sensor 14, and the target temperatures according to the heating profile derived by the electromagnetic field analysis unit 16, and causes the electromagnetic field analysis unit 16 to derive a heating profile which is obtained by modifying the original heating profile according to the result (difference) of the comparison. In FIG. 10, the control unit 10 detects differences between the detected temperatures of the parts 110a to 110e, and the target temperatures (the target temperature 1 and the target temperature 2), for example, at time X or time Y. When any difference is greater than or equal to a predetermined value, the control unit 10 causes the electromagnetic field analysis unit 16 to derive a heating profile which is obtained by modifying the original heating profile according to the result (difference) of the comparison.

The control unit 10 causes the plurality of antennas 13 to emit microwaves based on the modified heating profile.

In this modification, the flow of heat treatment of the object 110 is substantially the same as that of Embodiment 1, however, the processing in S109 has a characteristic. That is, in S109, the microwave heating device 1 performs heat treatment on the object 110. In the above process, the sensor 14 detects actual temperatures (temperature variations) of the parts 110a to 110e of the object 110, and the sensor processing unit 15 converts the results (measured values) into numerals based on the temperatures (temperature variations) obtained from the sensor 14. The control unit 10 compares between the targeted value of each block piece and the measured value. When the difference is greater than or equal to a predetermined value, the control unit 10 causes the electromagnetic field analysis unit 16 to conduct electromagnetic field analysis again so as to generate a modified heating profile in which the difference is compensated. The control unit 10 then causes the antennas 13 to emit microwaves by controlling the microwave generators 12 according to the modified heating profile. Consequently, the effect is achieved that the parts 110a to 110e of the object 110 are heated to respective desired temperatures with high accuracy.

As described above, not only that a simple and more accurate model for electromagnetic field analysis can be generated by the present embodiment, but also that the temperatures of the heated parts 110a to 110e of the object 110 can be made close to respective target temperatures.

That is, in the present embodiment, optimal heating control can be performed on the parts 110a to 110e by determining the difference between the target temperature by heating and the temperature actually attained by heating. Consequently, uneven heating of the object 110 is reduced, and ideal heating control can be achieved.

It is to be noted that in the present embodiment, the modified heating profile may use one of heating profiles which have been determined by previously conducted electromagnetic field analysis. In this case, it is assumed that the microwave heating device includes a storage which stores some heating profiles beforehand, and an optimal heating profile is read from the heating profiles stored in the storage and used. Consequently, the effect is achieved that processing related to generation of a modified heating profile can be reduced, and heating speed can be increased.

In the present embodiment, without being limited to the above case, a heating profile may be generated again as a modified heating profile by electromagnetic field analysis.

### Embodiment 3

In Embodiment 1 and Embodiment 2, the case has been described where a pseudo article is put instead of an object in the heating chamber inside 100 of the microwave heating device 1. In Embodiment 1 and Embodiment 2, the pseudo article is a block model which models an object.

On the other hand, in the present embodiment, the case will be described where an object is put in the heating chamber inside 100 of the microwave heating device 1, and a pseudo article is directly or indirectly attached to the parts of the object.

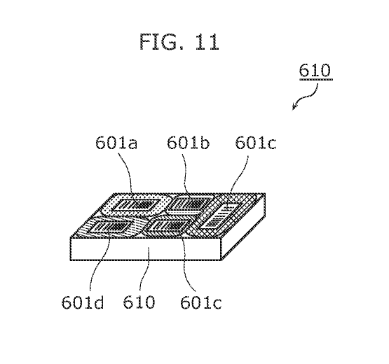

FIG. 11 is an illustration showing an object 610 to be heat treated in Embodiment 3. As illustrated in FIG. 11, the object 610 is labeled with bar codes 601a to 601e as a pseudo article.

That is, in the present embodiment, the parts of the object 610 are each labeled with a pseudo article. The pseudo article is previously assigned information indicating the characteristic of corresponding one of the parts. Here, the pseudo article indicates, for example, a bar code, and includes information of at least one of the size, shape, dielectric constant, and thermal conductivity of a corresponding part of the object 610. This individual information includes, for example, information of at least one of the size, shape, dielectric constant, and thermal conductivity of a corresponding block piece.

The configuration of the microwave heating device 1 in the present embodiment is the same as the configuration in Embodiment 1, and thus a description thereof is omitted. Hereinafter, a flow until the object 610 is heat treated in the present embodiment will be described.

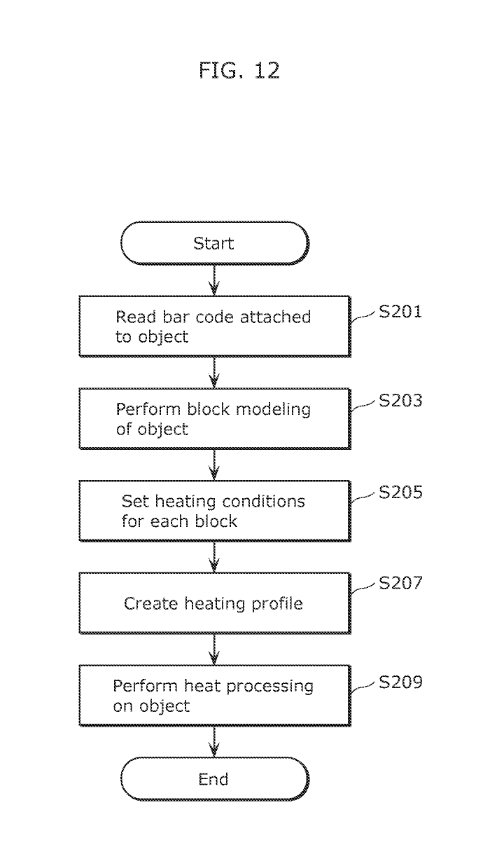

FIG. 12 is a flow chart illustrating a flow of processing until the object 610 is heat treated in Embodiment 3.

First, the object 610 which is to be heated is put in the heating chamber inside 100 of the microwave heating device 1 illustrated in FIG. 1. The microwave heating device 1 is then operated, and the information is read which is on the bar codes 601a to 601e attached to the object 610 (S201).

Specifically, the sensor 14 has a function of optically recognizing characters and symbols, and reads information from the bar codes 601a to 601e attached to the object 610, and outputs the information to the sensor processing unit 15. Based on the information obtained by the sensor 14, the sensor processing unit 15 extracts information including at least one of the size, shape, dielectric constant, and thermal conductivity of each of the parts of the object 610, and generates a three-dimensional model of the object 110.

Next, modeling of each part of the object 610 is performed (S203).

The modeling is processing in which the sensor processing unit 15 generates a three-dimensional model of the object 110 based on the extracted information by recognizing each part of the object 610 as a block, the object 610 being labeled with a pseudo article. The pseudo articles attached to the object 610 indicate, for example, the bar codes 601a to 601e, and are used to identify each part of the object 610 in terms of the concept of block. Each block is a distinct target to be controlled in heating.

Next, heating conditions are set for each of the blocks corresponding to the parts included in the object 610 (S205). Specifically, a user sets heating conditions for each block via the display and input operation unit 17. It is to be noted that the heating conditions for the blocks may be different from each other, or part or all of the heating conditions may be the same.

Next, the microwave heating device 1 generates a heating profile for performing heat treatment on the object 610 (S207).

Specifically, the electromagnetic field analysis unit 16 generates a heating profile based on the information of the bar codes 601a to 601e extracted by the sensor processing unit 15 in S203, and the heating conditions for the object 610 set in S205. The electromagnetic field analysis unit 16 may generate a heating profile for performing a single heat treatment on the entire object 610 depending on the set heating conditions. The electromagnetic field analysis unit 16 may generate a heating profile for performing different heat treatments for the parts included in the object 610 depending on the set heating conditions.

Next, the microwave heating device 1 performs heat treatment on the object 610 (S209).

Specifically, the microwave heating device 1 outputs microwaves from the antennas 13 by controlling the microwave generators 12 based on the generated heating profile. Subsequently, the microwave heating device 1 performs heat treatment on the object 110 placed in the heating chamber inside 100 by emitting microwaves to the object 610 from the antennas 13.

For example, assume that different heating conditions are set for the parts included in the object 610 in S205. In this case, the microwave heating device 1 does not uniformly heat the entire object 610, but heats the parts of the object 610 under different conditions.

The heating conditions set for each of the blocks corresponding to the parts included in the object 610 are, for example, conditions of a temperature range to which the block pieces are heated. For example, it is also possible to set a condition that some of the blocks are not heated. More specifically, when the object is foodstuff, temperature treatment may be performed with different temperature targets according to the foodstuffs included in the object, or some of the foodstuffs may not be heated.

In this manner, the microwave heating device 1 performs heat treatment on the object 610.

As described above, a simple and more accurate model for electromagnetic field analysis can be generated by the microwave heating device 1 in Embodiment 1.

In addition, in the present embodiment, a heating profile for performing optimal heating on the object 610 can be easily and accurately generated without using a model block which is substituted for the object 610. Consequently, the effect is achieved that the microwave heating device 1 is easy to use for users.

In the present embodiment, the case has been described where the object 610 is labeled with the bar codes 601a to 601e, however, the invention is not limited to this case. The number of bar codes is not limited to the number in the above example, and may be more or less. Similarly to Embodiment 1, the bar codes 601a to 601e may be each a one-dimensional bar code or a two-dimensional bar code. As long as the block corresponding to each of the parts included in the object 610 can be identified, a simple symbol may be used instead of the bar code.

[Modification]

In Embodiment 2, the case has been described where the pseudo article labeled on each part of the object 610 is assigned information indicating the characteristic of a corresponding part of the object 610 and including at least one of the size, shape, dielectric constant, and thermal conductivity of the corresponding part. In this modification, a case will described where the information assigned to the pseudo article further includes heating conditions for a corresponding part of the object 610.

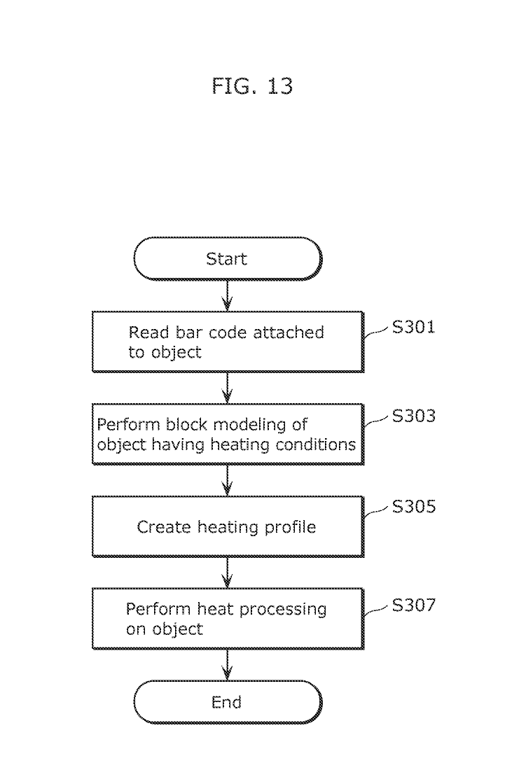

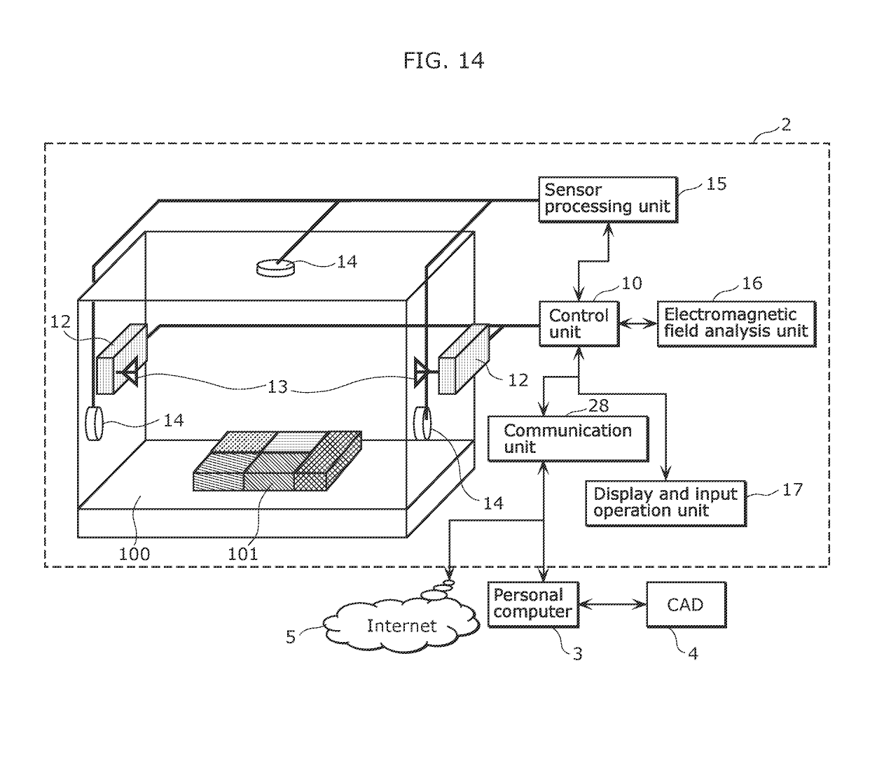

FIG. 13 is a flow chart illustrating a flow of processing until the object 610 is heat treated in a modification of Embodiment 3.

First, in this modification, similarly to FIG. 11, the object 610 labeled with the bar codes 601a to 601e is used.

The present modification has a distinctive feature in that the information expressed by the bar codes 601a to 601e includes, as the information indicating the characteristic of the corresponding parts of the object 610, information indicating heating conditions in addition to the information of at least one of the size, shape, dielectric constant, and thermal conductivity of the corresponding parts. Here, the information indicating heating conditions include at least one of the information as to whether or not each part of the object 610 should be heated, and the information as to how high is each part of the object 610 heated when the part is heated.

First, the object 610 which is to be heated is placed in the heating chamber inside 100 of the microwave heating device 1 illustrated in FIG. 1. The microwave heating device 1 is then operated, and the information is read which is on the bar codes 601a to 601e attached to the object 610 (S301).

Specifically, similarly to S201, the sensor 14 has a function of optically recognizing characters and symbols, and reads information from the bar codes 601a to 601e attached to the object 610, and outputs the information to the sensor processing unit 15. The sensor processing unit 15 extracts the information of at least one of the size, shape, dielectric constant, and thermal conductivity of each part of the object 610 and the information indicating heating conditions, based on the information obtained by the sensor 14.

Next, modeling of each part of the object 610 is performed (S303). The processing in S303 is similar to the processing in S203 described above, thus a description is omitted.

Next, the microwave heating device 1 generates a heating profile for performing heat treatment on the object 610 (S305).

Specifically, the electromagnetic field analysis unit 16 generates a heating profile based on the information which has been extracted by the sensor processing unit 15 in S301 and corresponds to the bar codes 601a to 601e.

Next, the microwave heating device 1 performs heat treatment on the object 610 (S307). The processing in S307 is similar to the processing in S209 described above, thus a description is omitted.

In this manner, the microwave heating device 1 performs heat treatment on the object 610.

As described above, a simple and more accurate model for electromagnetic field analysis can be generated by this modification.

In this modification, a step of setting heating conditions for a block corresponding to any part of the object 610 is not necessary. This is because heating conditions are included in the information indicated by the bar codes 601a to 601e labeled on the object 610 in this modification. The electromagnetic field analysis unit 16 generates a heating profile which determines whether or not each part of the object 610 should be heated, and when any part is heated, how high is the part heated, according to the information indicating heating conditions. Therefore, a user does not need to set heating conditions for each block himself or herself.

In this modification, in contrast to Embodiments 1 and 2, it is not necessary to use a block model by labeling a pseudo article such as a bar code on the object. In contrast to Embodiment 3, a user does not need to set heating conditions for each part of the object himself or herself. Consequently, the effect is achieved that not only that optimal heating for the object can be performed, but also that the microwave heating device 1 is even more easy to use for users.

In this modification, the electromagnetic field analysis unit 16 basically determines heating conditions for the object 610 and generates a heating profile according to the information indicated by the bar codes (pseudo articles) labeled on the object 610, however, the invention is not limited to this. For example, heating conditions may be determined according to the preference of a user, and the heating conditions included in the heating profile derived by the electromagnetic field analysis unit 16 may be modified.

In this modification, the object 610 is labeled with the five bar codes (the bar codes 601a to 601e), however, the number of bar codes is not limited to five. The bar codes 601a to 601e may be each a one-dimensional bar code or a two-dimensional bar code. As long as a block corresponding to a part included in the object can be identified, a simple symbol may be used as an example of a pseudo article instead of a bar code.

### Embodiment 4

In Embodiments 1 to 3, the case has been described where the microwave heating device generates a three-dimensional model for the object, however, the invention is not limited to this case. In the present embodiment, a case will be described where the three-dimensional model generated by the microwave heating device is modified by an external device not included in the microwave heating device.

FIG. 14 is a diagram illustrating a configuration of a microwave heating device 2 in Embodiment 4. The components the same as those in FIG. 1 are labeled with the same symbols, and a description is omitted.

The microwave heating device 2 illustrated in FIG. 14 differs from the microwave heating device 1 in Embodiment 1 in that the new configuration includes a communication unit 28.

The communication unit 28 is an example of the communication unit in the present invention, and configured to transmit a model for the object, that is, a three-dimensional model for the object generated by the sensor processing unit 15, and to receive modification information which indicates a modified three-dimensional model. Specifically, the communication unit 28 is connected to a personal computer 3 on an intranet, and configured to transmit the information held by the microwave heating device 2 and to receive information to be used by the microwave heating device 2. In the present embodiment, a three-dimensional model generated by the sensor processing unit 15 is outputted to an external personal computer 3, and a three-dimensional model modified by the personal computer 3 is received and used by the electromagnetic field analysis unit 16.

It is to be noted that the communication unit 28 may be connected to the Internet network 5.

The personal computer 3 is an example of an external device, and is, for example, a personal computer and allows CAD 4 to be executed. The personal computer 3 can retrieve and save the information in the microwave heating device 2 via the communication unit 28. In addition, the personal computer 3 allows a three-dimensional model generated by the microwave heating device 2 to be modified or created by the processing of CAD 4.

The CAD 4 is software to generate, modify, and/or add a three-dimensional model for electromagnetic field analysis, and is, for example, CAD (computer-aided design). The CAD 4 is executed on the personal computer 3.

With the above configuration, the microwave heating device 2 can output a three-dimensional model generated by the sensor processing unit 15 to an external device, and receive a three-dimensional model modified by the external device. In this manner, a three-dimensional model can be modified by an external device (personal computer 3), thus the block pieces included in a block model can be changed by the CAD 4 without creating a new block model for the object. That is, by using a three-dimensional model generated by the sensor processing unit 15, it is possible to easily generate a modified three-dimensional model or create a new three-dimensional model.

As described above, a simple and more accurate model for electromagnetic field analysis can be generated by the microwave heating device 2 in the present embodiment.

In the present embodiment, the case has been described where the CAD 4 is executed on the personal computer 3 to modify or add a three-dimensional model, however, the invention is not limited to this case. For example, the display and input operation unit 17 may have a function of generating a three-dimensional model and may modify or add the information of a three-dimensional model generated by the sensor processing unit 15. Similar effects can be achieved in this case, too,

### Embodiment 5

In Embodiments 1 to 4, the case has been described where the microwave heating device generates a heating profile for the object by electromagnetic field analysis, however, the invention is not limited to this case. In the present embodiment, a case will be described where an external specific-use device not included in the microwave heating device generates a heating profile for the object by electromagnetic field analysis.

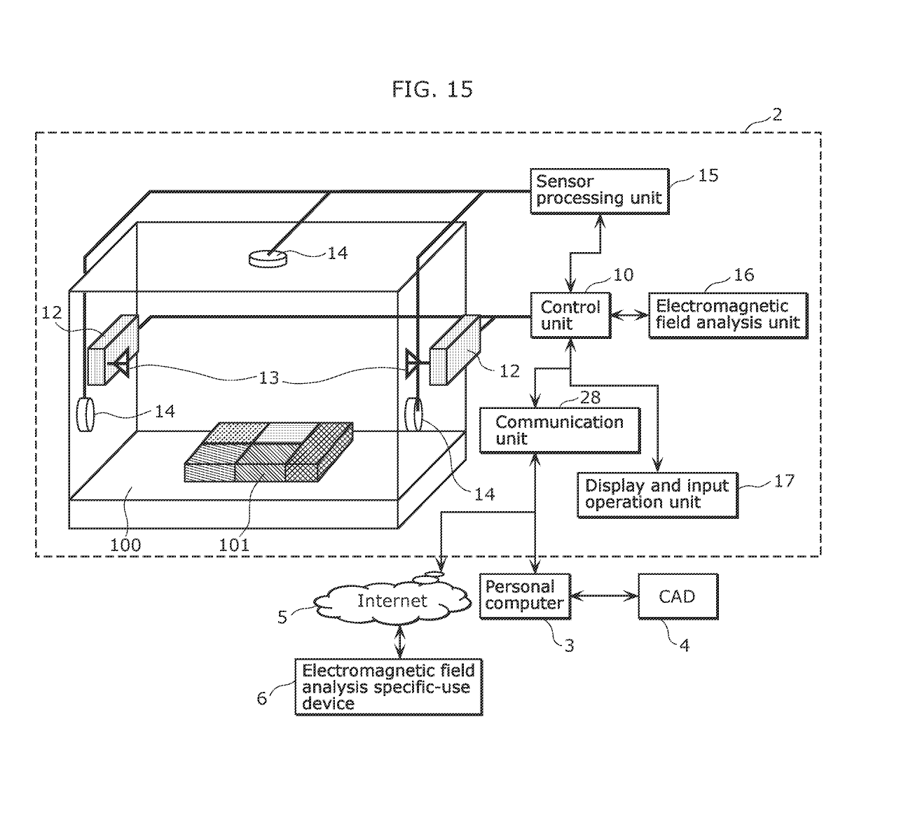

FIG. 15 is a diagram illustrating the configuration of the microwave heating device in Embodiment 5. The components the same as those in FIGS. 1 and 14 are labeled with the same symbols, and a description is omitted.

An electromagnetic field analysis specific-use device 6 is a specific-use device which is connected to the Internet network 5 and conducts electromagnetic field analysis. The electromagnetic field analysis specific-use device 6 acquires from the communication unit 28 via the Internet network 5 a three-dimensional model for electromagnetic field analysis generated by the sensor processing unit 15 or the personal computer 3, and the heating conditions for the object. The electromagnetic field analysis specific-use device 6 generates a heating profile for the object by electromagnetic field analysis based on the heating conditions and the acquired three-dimensional model for electromagnetic field analysis which has been generated by the sensor processing unit 15 or the personal computer 3. The electromagnetic field analysis specific-use device 6 transmits the generated heating profile of the object to the communication unit 28.

With this configuration, calculation for generating a heating profile can be performed at a high speed by using the electromagnetic field analysis specific-use device 6 which has high processing performance of electromagnetic field analysis. Thus, when complicated image processing is necessary and the processing load for modifying and adding a three-dimensional model is high, a significant effect can be achieved because particularly, processing speed of generating a heating profile can be increased.

The processing performed by the electromagnetic field analysis specific-use device 6 may be achieved by the personal computer 3. In this case, the personal computer 3 executes software which achieves the function of electromagnetic field analysis

When the processing load for modifying and adding a three-dimensional model is not so high, the effect is achieved that the processing speed of generating a heating profile can be increased by using the personal computer 3.

As described above, a simple and more accurate model for electromagnetic field analysis can be generated by the microwave heating device according to an aspect of the present invention.

So far, the microwave heating device according to the present invention has been described based on the embodiments, however, the present invention is not limited to these embodiments. As long as not departing from the spirit of the present invention, modified embodiments obtained by making various modifications, which occur to those skilled in the art, to the above embodiments, and the embodiments that are constructed by combining the components in different embodiments are also included in the scope of the present invention.

### INDUSTRIAL APPLICABILITY

The present invention has a function of facilitating the generation of a three-dimensional model for electromagnetic field analysis using a block model for the object. The invention can be applied to a microwave heating device for generating a microwave heating control profile, and particularly to a microwave heating device used for application of chemical reaction, drying, and heating with microwaves.

### REFERENCE SIGNS LIST

1, 2, 90 Microwave heating device
3 Personal Computer
4 CAD
5 Internet network
6 Electromagnetic field analysis specific-use device
10 Control unit
12 Microwave generator
13 Antenna
14 Sensor
15 Sensor processing unit
16 Electromagnetic field analysis unit
17 Display and input operation unit
28 Communication Unit
100 Heating chamber inside
101, 201, 301, 302, 401, 501 Block model
101a, 101b, 101c, 101d, 101e, 201a, 201b, 201c, 201d, 201e, 301a, 301b, 301c, 301d, 301e, 401a, 401b, 401c, 401d, 401e, 5011, 5012, 5013, 5014, 5015, 5016, 5017, 5018, 5019, 5020 Block piece
110, 610, 951, 952 Object
110a, 110b, 110c, 110d, 110e Part
311a, 311b, 311c, 311d, 311e One-dimensional bar code
321a, 321b, 321c, 321d, 321e Two-dimensional bar code
601a, 601b, 601c, 601d, 601e, 5020a Bar code
900 Chamber inside
962 Turntable

1. A microwave heating device for heating an object which is to be heated based on a heating profile,
the object having a plurality of parts,
the microwave heating device comprising:
a plurality of antennas which emits microwaves to an inside of a heating chamber;
a sensor which detects information from a pseudo article in the heating chamber, the information indicating a characteristic of each of the parts, the pseudo article being assigned the information;
a heating condition acquisition unit configured to acquire heating conditions for the object;
an electromagnetic field analysis unit configured to derive a heating profile by electromagnetic field analysis based on the information detected by the sensor and the heating conditions acquired by the heating condition acquisition unit, the heating profile including microwave emitting conditions for the object; and
a control unit configured to control performance of microwaves emitted from the antennas, based on the heating profile derived by the electromagnetic field analysis unit.

2. The microwave heating device according to claim 1,
wherein the electromagnetic field analysis unit is configured to generate a three-dimensional model using the information detected by the sensor and to derive the heating profile satisfying the heating conditions, by using the three-dimensional model.

3. The microwave heating device according to claim 1,
wherein the pseudo article includes a plurality of blocks, each of which corresponds to a different one of the parts and is assigned the information on the different part.

4. The microwave heating device according to claim 3,
wherein instead of the object, the pseudo article is placed in the heating chamber.

5. The microwave heating device according to claim 1,
wherein the information includes at least one of a position, a size, a shape, a dielectric constant, and a thermal conductivity.

6. The microwave heating device according to claim 3,
wherein lines are added to enhance the outlines of the blocks, and the sensor recognizes boundaries between the blocks with the lines to detect the information from the blocks respectively corresponding to the parts.

7. The microwave heating device according to claim 3,
wherein a surface of each of the blocks is labeled with a symbol which indicates the corresponding information, and the sensor detects the information by recognizing the symbol.

8. The microwave heating device according to claim 7,
wherein the symbol is a bar code.

9. The microwave heating device according to claim 3,
wherein each of the blocks is labeled with a color which indicates the corresponding information, and
the sensor detects the information by recognizing the color.

10. The microwave heating device according to claim 1,
wherein the pseudo article includes a plurality of blocks stacked in layers,
the blocks included in the pseudo article respectively correspond to the parts, and
out of the information assigned to the blocks included in the pseudo article, information to be assigned to a visually unrecognizable block from outside is assigned to a block visible from a surface of the pseudo article instead of the visually unrecognizable block.

11. The microwave heating device according to claim 1,
wherein the object is placed in the heating chamber and heated by microwaves which are emitted from the antennas,
the sensor further detects temperatures of the parts of the object placed in the heating chamber,
the control unit is configured to compare differences between the temperatures of the parts of the object detected by the sensor and a target temperature according to the heating profile derived by the electromagnetic field analysis unit,
the electromagnetic field analysis unit is configured to derive an updated heating profile according to the differences, and
the control unit is configured to control an operation of the antennas based on the updated heating profile to cause the antennas to emit microwaves from the antennas.

12. The microwave heating device according to claim 1, further comprising
a communication unit configured to transmit a model for the object and to receive modification information indicating a modified model for the object,
wherein when the communication unit receives the modification information, the electromagnetic field analysis unit derives the heating profile based on the modification information and the heating conditions inputted to the heating condition acquisition unit.

13. The microwave heating device according to claim 1,
wherein the object has a plurality of parts and is placed in the heating chamber of the microwave heating device, and
the parts of the object are each labeled with the pseudo article.

14. The microwave heating device according to claim 1,
wherein the pseudo article is further assigned a heating condition for a corresponding one of the parts, the heating condition being included in the information indicating a characteristic of each of the parts.

15. The microwave heating device according to claim 14,
wherein the heating condition includes a condition which indicates that whether or not a corresponding one of the parts is to be heated and a level of heating when the corresponding part is to be heated.

16. The microwave heating device according to claim 14,
wherein when heating conditions different from the heating conditions assigned to the pseudo article are inputted, the heating condition acquisition unit is configured to acquire the different heating conditions as heating conditions for the object instead of the heating conditions assigned to the pseudo article.
